(19) United States
(12) Patent Application Publication
(10) Pub. No.: US 2011/0058600 A1
(43) Pub. Date: Mar. 10, 2011

(54) MULTIPLE TUNER ATSC TERRESTRIAL DTV RECEIVER FOR INDOOR AND MOBILE USERS

(75) Inventor: LIN YANG, FREMONT, CA (US)

(73) Assignee: LEGEND SILICON CORP., FREMONT, CA (US)

(21) Appl. No.: 12/554,925

(22) Filed: Sep. 7, 2009

(51) Int. Cl. H04L 27/01

(52) U.S. Cl. 375/233

(57) ABSTRACT

A device is provided. the device comprises a maximum ratio combining (FD-MRC-DFE), a first device down stream to the FD-MRC-DFE; and a second device upstream to the maximum ratio combining (FD-MRC-DFE) having a second point directly connected to a first point within the first device. The method for producing the device is also provided.

### CROSS-REFERENCE TO OTHER APPLICATIONS

The following application of common assignee herewith is related to the present application, and is herein incorporated by reference in their entireties:

U.S. patent application Ser. No. 12/512,901 with attorney docket number LSFFT-121.

### FIELD OF THE INVENTION

The present invention relates generally to an application in a digital television system, more specifically the present invention relates to a multiple tuner ATSC terrestrial DTV receiver for indoor and mobile users.

### BACKGROUND

Single carrier terrestrial digital television (DTV) systems are deployed in the countries such as Unite States (ATSC or Advanced Television Systems Committee), Canada, and other countries.

For in-door or mobile users, accurate channel estimation during time periods between known, received intervals is required for receiving wireless signals. In addition to the superposition diversity of multiple tuner maximum ratio combining using Minimum Mean Square Error (MMSE) decision feedback equalization (see U.S. patent application Ser. No. 12/512,901), The challenge is to desirous to provide a receiver having accurate channel estimation during time periods between known, received intervals.

### SUMMARY OF THE INVENTION

A method and device for channel estimation in an in-door receiver is provided.

A method and device for channel estimation in an in-door digital television (DTV) is provided.

A method and device for channel estimation in an in-door terrestrial (DTV) is provided.

A method and device for channel estimation in an in-door digital television (DTV) using a feedback signal from within a forward error control (FEC) block is provided.

A method and device for channel estimation in an in-door single carrier digital television (DTV) using a feedback signal from within a forward error control (FEC) block is provided.

A method and device for channel estimation in an mobile receiver is provided.

A method and device for channel estimation in an mobile digital television (DTV) is provided.

A method and device for channel estimation in an mobile terrestrial (DTV) is provided.

A method and device for channel estimation in an mobile digital television (DTV) using a feedback signal from within a forward error control (FEC) block is provided.

A method and device for channel estimation in an mobile single carrier digital television (DTV) using a feedback signal from within a forward error control (FEC) block is provided.

A device is provided. The device comprises a maximum ratio combining (FD-MRC-DFE), a first device down stream to the FD-MRC-DFE; and a second device upstream to the maximum ratio combining (FD-MRC-DFE) having a second point directly connected to a first point within the first device. The method for producing the device is also provided.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1A is a first example of a first receiver in accordance with some embodiments of the invention.

FIG. 1B is a second example of a first receiver in accordance with some embodiments of the invention.

FIG. 2 is a prior art ATSC standard.

FIG. 3 is an example of a channel estimation diagram in accordance with some embodiments of the invention.

FIG. 4 is an example of forming or obtaining a feedback signal from a FEC block in accordance with some embodiments of the invention.

FIG. 5 is an example of a detailed channel estimation diagram between two known received sequences in accordance with some embodiments of the invention.

FIG. 5A is an example of a generic channel estimation diagram between two known received sequences in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to carrier recovery, symbol/timing recovery, frequency down conversion, baseband signal filter, frame synchronization, and channel estimation for the received multiple channel signals from either single or multiple antennae with multiple tuners and then using channel decoder to overcome bad data or error in a coding context. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

It will be appreciated that embodiments of the invention described herein may be comprised of one or more conventional processors and unique stored program instructions that control the one or more processors to implement, channel estimation for received multiple channel signals. The non-processor circuits may include, but are not limited to, a radio receiver, a radio transmitter, signal drivers, clock circuits, power source circuits, and user input devices. As such, these functions may be interpreted as steps of a method to equalize the received multiple channel signals. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention contemplates a wireless receiver not only used in DTV systems, but also used in such wireless systems as a personal digital assistant (PDA), a mobile PC, an Internet PC, a cell phone, or any WiMax or LTE device, as well as any mobile indoor device.

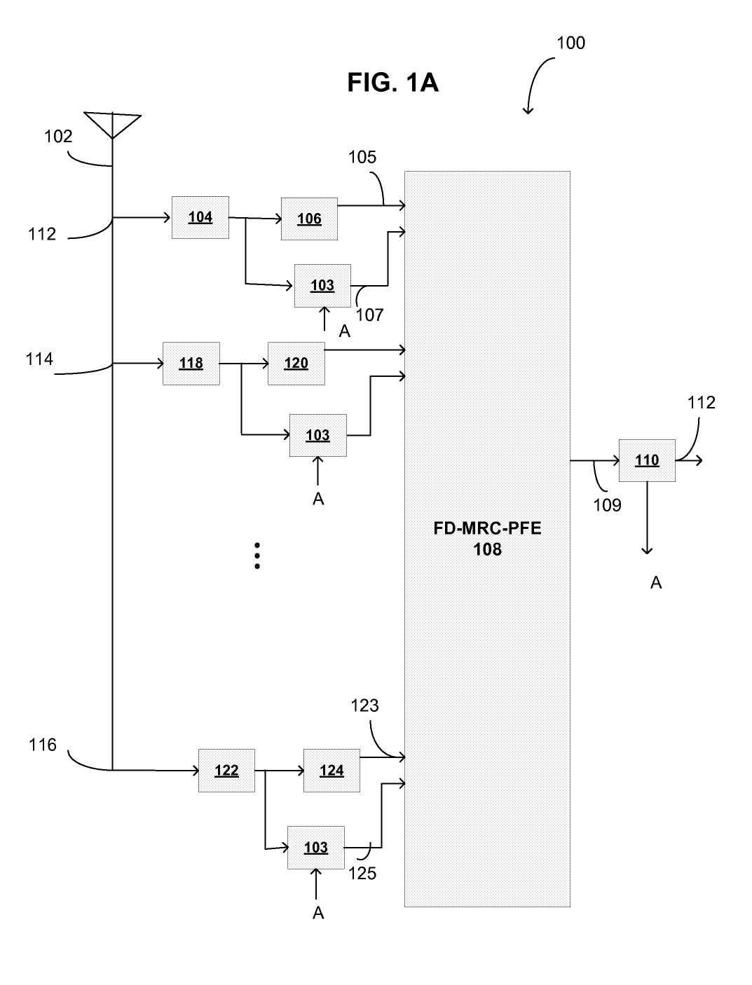

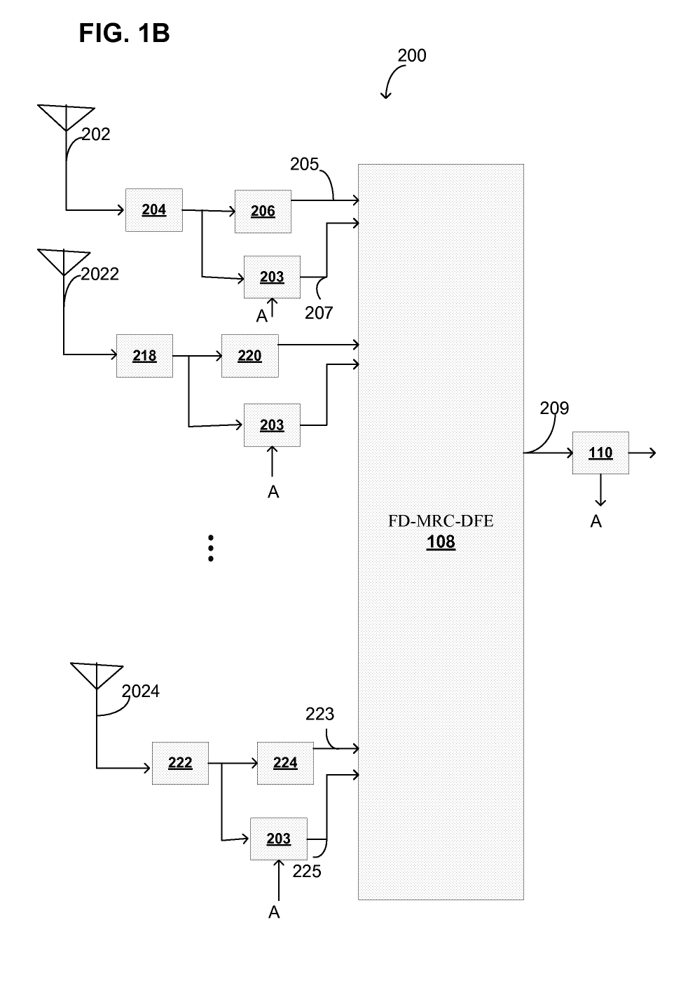

Referring to FIG. 1A, an example of a first receiver 100 in accordance with some embodiments of the invention is shown. A received signal is received by antenna 102. As can be seen, receiver 100 is a single antenna receiver such as a single antenna digital TV receiver with multiple tuners. In turn, a first tuner 104 processes the received signal r. The tuner 104 generate its proprietary signal to noise ratio based upon the tuner's noise characteristics. The received signal r, with tuner's noise characteristics, is subjected to preprocessing 106. Preprocessing comprises down conversion, carrier recovery, symbol/timing recovery, base-band signal filter, frame synchronization, and Signal to Noise Ratio (SNR). In addition to these operations, a channel estimation block 103 receives the received signal r, and also receives a feedback signal A in order to generate an output 107. After preprocessing, the respective signal 105, along with its time domain channel estimation information 107, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. Within the FEC unit 110, the feedback A is generated. This forms the first signal path 112.

Similarly, for a second signal path 114, the received signal r is received by antenna 102. In turn, a second tuner 118 processes the received signal r. The tuners 118 generate its proprietary signal to noise ratio (SNR) based upon the tuner's noise characteristics. The received signal, with its noise characteristics, is subjected to preprocessing 120. Preprocessing comprises down conversion, carrier recovery, symbol/timing recovery, base-band signal filter, frame synchronization, and Signal to Noise Ratio (SNR). In addition to these operations, a channel estimation block receives the received signal r, and also receives a feedback signal A in order to generate a channel estimation output. After preprocessing, the respective signal, along with its time domain channel estimation information, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. Within the FEC unit 110, the feedback A is generated. This forms the first signal path 112.

Therefore, generically, of the Nth path 116, the received signal is received by antenna 102. In turn, a first tuner 122 processes the received signal. The tuners 122 generate its proprietary signal to noise ratio based upon the tuner's noise characteristics. The received signal, with its noise characteristics, is subjected to preprocessing 124.

Preprocessing comprises down conversion, carrier recovery, symbol/timing recovery, base-band signal filter, frame synchronization, and Signal to Noise Ratio (SNR). In addition to these operations, a channel estimation block 123 receives the received signal r, and also receives a feedback signal A in order to generate an output 125. After preprocessing, the respective signal 123, along with its time domain channel estimation information 125, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. Within the FEC unit 110, the feedback A is generated. This forms the first signal path 112.

Referring to FIG. 1B, an example of a second receiver 200 in accordance with some embodiments of the invention is shown. A received signal r is received by a plurality of antennae comprising a set of N antennae (N being a natural number, with N greater than or equal to 2). Each antenna has its own tuner. Each antenna and an associated tuner form a signal path.

A first tuner 204 processes the received signal r. The tuners 204 generate its proprietary signal to noise ratio based upon the tuner's noise characteristics. The received signal, with its noise characteristics, is subjected to preprocessing 206.

Preprocessing comprises down conversion, carrier recovery, symbol/timing recovery, base-band signal filter, frame synchronization, and Signal to Noise Ratio (SNR). In addition to these operations, a channel estimation block 203 receives the received signal r, and also receives a feedback signal A in order to generate an output 207. After preprocessing, the respective signal 205, along with its time domain channel estimation information 207, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. Within the FEC unit 110, the feedback A is generated. This forms the first signal path 112.

Similarly, for a second signal path 2022, the received signal is received by antenna 2022. In turn, a second tuner 218 processes the received signal. The tuners 218 generate its proprietary signal to noise ratio based upon the tuner's noise characteristics. The received signal, with its noise characteristics, is subjected to preprocessing 220.

Preprocessing comprises down conversion, carrier recovery, symbol/timing recovery, base-band signal filter, frame synchronization, and Signal to Noise Ratio (SNR). In addition to these operations, a channel estimation block 203 receives the received signal r, and also receives a feedback signal A in order to generate an output. After preprocessing, the respective signal, along with its time domain channel estimation information, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. Within the FEC unit 110, the feedback A is generated. This forms the first signal path 112.

This forms the second signal path 212. Note that only three paths are shown. However, in practice, up to N (N being a natural number, with N greater than or equal to 2) paths may be formed.

Therefore, generically, of the Nth path 2024, the received signal r is received by antenna 2024. In turn, a Nth tuner 222 processes the received signal. The tuner 222 generate its proprietary signal to noise ratio based upon the tuner's noise characteristics. The received signal, with its noise characteristics, is subjected to preprocessing 224. Preprocessing comprises down conversion, carrier recovery, symbol/timing recovery, base-band signal filter, frame synchronization, and Signal to Noise Ratio (SNR). In addition to these operations, a channel estimation block 103 receives the received signal r, and also receives a feedback signal A in order to generate an output 207. After preprocessing, the respective signal 205, along with its time domain channel estimation information 207, are separately input into a FD-MRC-DFE (i.e. Frequency Domain Maximum Ratio Combining Decision Feedback Equalizer) block 108. The output thereof is further subjected to down stream processing including Forward Error control (FEC) 110, etc. Within the FEC unit 110, the feedback A is generated.

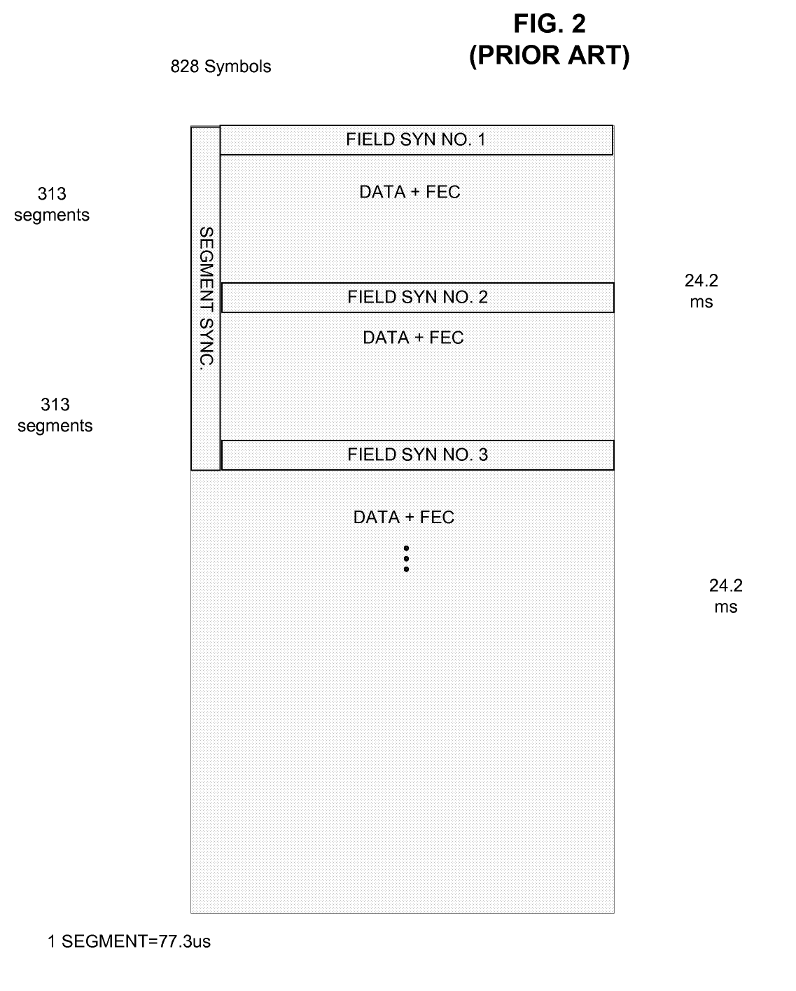

Referring to FIG. 2, a known ATSC diagram is shown. Note the time gap between field synchronization signals. The present invention addresses channel estimation between these gaps.

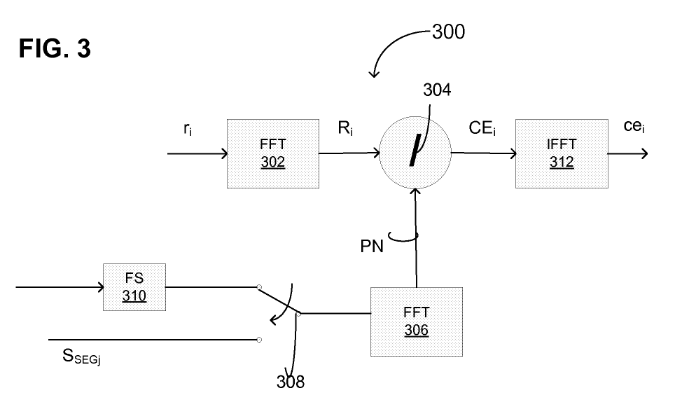

Referring to FIG. 3, an example of channel estimation 300 is shown. A received signal rᵢ is input into a first Fourier transformers (FFT) 302. The transformed, frequency domain signal Rᵢ is subjected to divider 304. Divider 304 has another input PN which is the transformed results of inputs subjected to a second fast Fourier transformers (FFT) 306. There are two inputs for second fast Fourier transformers (FFT) 306 via a switch 308 that selectively selects a field synchronization signal 310 and a segment signal S_{SEGj} existing between two field synchronization signals 310 along a time line t.

The quotient CEᵢ of divider 304 is the channel estimation, which is subjected to an inverse Fourier transformer (IFFT) 312 to be transformed back to the time domain ceᵢ. The operations of FIG. 3 are as follows. Between field synchronization signals 310 or in the gap, 310 segment signal S_{SEGj} (j=1, 2, . . . ) is used consecutively (for details, see figures infra). If the next or consecutive field synchronization signal 310 arrives,

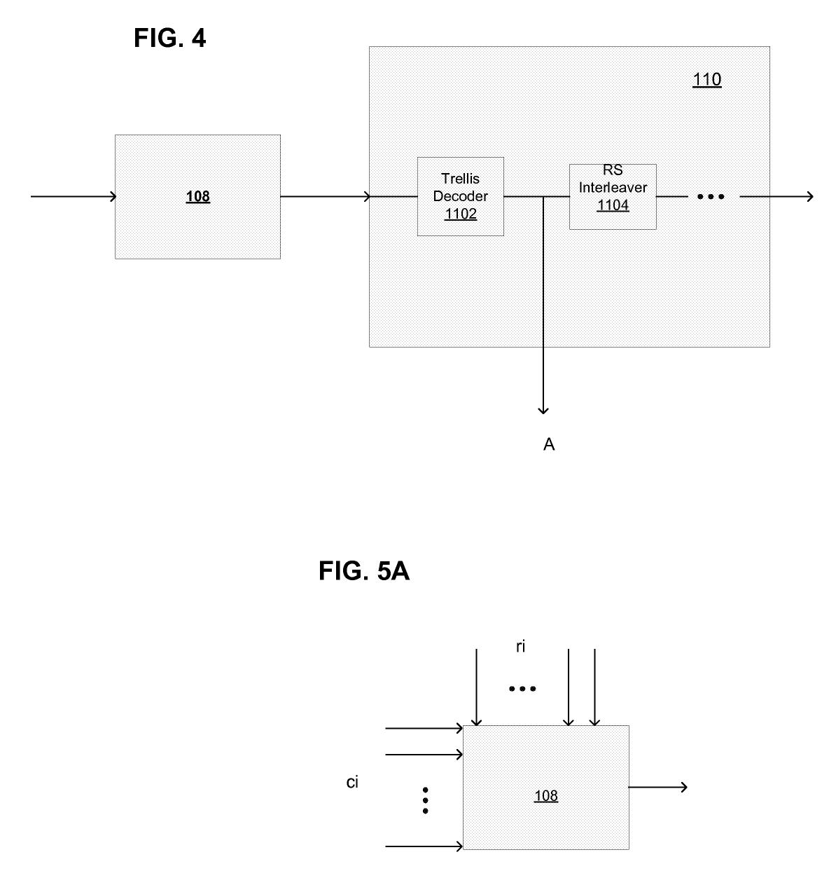

Referring to FIG. 4, the point of feedback A is shown. After 108, the processed, received signal r enters 110. 110 is further subdivided into a 1102 and 1104, as well as other subdivided blocks further down stream. Between or from the output of 1102 and the input to 1104, feedback A is formed or leads out to feed back to 203/103 of FIGS. 1A-1B.

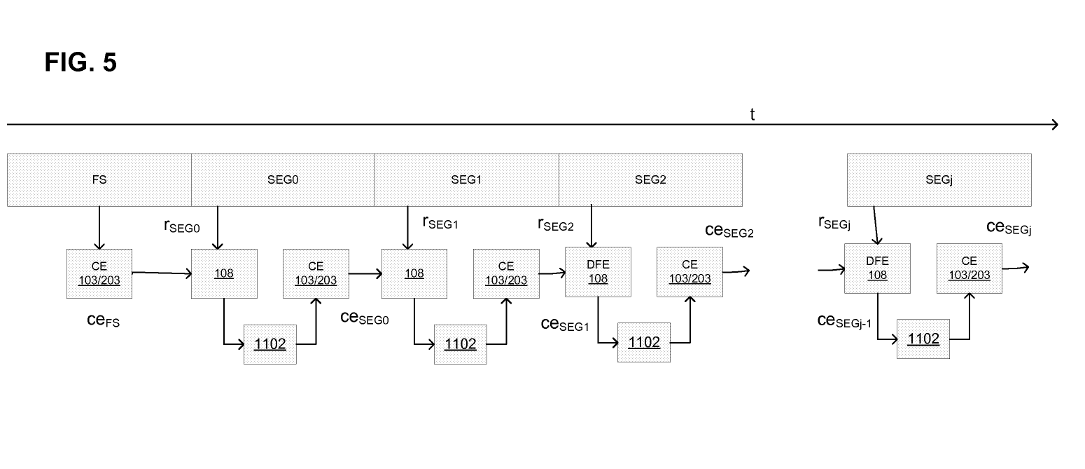

Referring to FIG. 5, a detailed diagram depicting channel estimations between field synchronizations signals is shown. when time line progresses to a field synchronization FS, channel estimation is performed using the FS. However, between two FSs, there is no known sequence for channel estimation purposes. The present invention contemplates to advantageously use the Frequency Domain Maximum Ratio Combining Decision Feedback Equalizer (FD-MRC-DFE) processesed information to do the channel estimation. The FD-MRC-DFE process combines information from a plurality of tuners. In other words, channel information coming from tuners of other paths (see U.S. patent application Ser. No. 12/512,901) are combined and used for the channel estimation. Turning now to the drawings, FS signal is used for a typical, known channel estimation. Between FSs are the data portion of a transmission. The data portion is divided into segments (SEG₀, . . . , SEGⱼ, . . . , SEGₘ). Each segment has an associated received signal r portion r_{SEGj}. A is segmented into ce_{FS}, ce_{SEG0}, ce_{SEG1}, . . . , ce_{SEGj}, etc. But upon the FS signal is used and until the next FS signal occurs, one cannot rely with confidence on the previous FS for channel estimation. This is more true or evident under indoor or mobile circumstances.

Referring to FIG. 5A, a generic diagram depicting channel estimations between field synchronizations signals are shown. a plurality of received signals ri is input into block 108, where i spans 1 to n. Similarly, a plurality of channel estimation signals ci is input into block 108, where i spans 1 to n.

It is noted that for in-door receivers, due to dynamic multipath resulting from living object (e.g. human) movement inside a man made or otherwise enclosure, channel estimation within the time gap between standard or known channel estimation is required.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A device comprising:
a Frequency Domain Maximum Ratio Combining Decision Feedback Equalizer (FD-MRC-DFE),
a first device down stream to the FD-MRC-DFE; and
a second device upstream to the FD-MRC-DFE having a second point directly connected to a first point within the first device.

2. The device of claim 1 is associated with a single antenna being coupled to a plurality of tuners having the FD-MRC-DFE block.

3. The device of claim 1 is associated with a plurality of antennae being coupled to a plurality of tuners having the FD-MRC-DFE block.

4. The device of claim 1, wherein the single carrier environment comprises the ATSC standard.

5. The device of claim 1, wherein the device is used in a DTV receiver.

6. The device of claim 1, wherein the device is used in a mobile wireless receiver.

7. The device of claim 1, wherein the second point possesses information that inputs same directly into a channel estimation block.

8. The device of claim 1, wherein the first point possesses information that is an output of a Forward Error Control (FEC).

9. The device of claim 8, wherein, the first point possesses information that is an output of a Trellis decoder formed with the FEC.

10. The device of claim 1, wherein a feedback signal that spans the first point and the second point comprises a known signal that is timely available, and a segmented signal if known signals are not timely available.

11. A method comprising:
providing a Frequency Domain Maximum Ratio Combining Decision Feedback Equalizer (FD-MRC-DFE),
providing a first device down stream to the FD-MRC-DFE; and
providing a second device upstream to the FD-MRC-DFE having a second point directly connected to a first point within the first device.

12. The method of claim 1 is associated with a single antenna being coupled to a plurality of tuners having the FD-MRC-DFE block.

13. The method of claim 1 is associated with a plurality of antennae being coupled to a plurality of tuners having the FD-MRC-DFE block.

14. The method of claim 1, wherein the single carrier environment comprises the ATSC standard.

15. The method of claim 1, wherein the device is used in a DTV receiver.

16. The method of claim 1, wherein the device is used in a mobile wireless receiver.

17. The method of claim 1, wherein the second point possesses information that inputs same directly into a channel estimation block.

18. The method of claim 1, wherein the first point possesses information that is an output of a Forward Error control (FEC) block.

19. The method of claim 18, wherein, the first point possesses information that is an output of a Trellis decoder formed with the FEC.

20. The method of claim 1, wherein a feedback signal that spans the first point and the second point comprises a known signal that is timely available, and a segmented signal if known signals are not timely available.
